(19) United States
(12) Patent Application Publication
(10) Pub. No.: US 2006/0116114 A1
(43) Pub. Date: Jun. 1, 2006

(54) Wireless caller ID system

(76) Inventor: Marwan M. Kadado, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/001,552

(22) Filed: Nov. 30, 2004

(51) Int. Cl. H04M 3/42

(52) U.S. Cl. 455/415

(57) ABSTRACT

In some embodiments, an arrangement is provided to display information about an incoming phone call (e.g., phone number, caller's identity, etc.) on a television screen, a screen of a computer system (e.g., a desktop personal computer (PC) system, a laptop computer system, or a handheld computer system), a separate caller ID device, or any other devices having a display (e.g., a microwave oven, a refrigerator that has a display screen). A receiving unit may be located in such a displaying device to receive, wirelessly, at least a portion of the information about the incoming call from at least one of a transmitting unit and a control unit. The receiving unit causes the information to be displayed on the displaying device in any display mode of the device. Other embodiments are also described and claimed.

### BACKGROUND

Caller identification devices (“Caller ID”) have been popularly used at homes to help people identify the caller of an incoming phone call before they pick up the phone. Caller identities provided by a caller ID help a receiving party screen calls and hence the party may only answer the calls that are important. In addition, a caller ID allows a person to see who has called even if they do not leave a voice message. A caller ID may be a stand-alone device or an integral part of a telephone. Although a traditional caller ID is implemented by hardware circuits, today a caller ID may be implemented by software programs. Typically a caller ID is connected to a phone jack through a telephone line.

One type of caller ID is built to display a caller's phone number/identity on a television (TV) screen. At one end, such a caller ID is connected to a TV set through a composite or S-video connector of the TV. At the other end, the caller ID may be connected to a phone jack through telephone lines. However, a phone jack may be far away from where a TV is located or may not be easily accessible. Although a wireless device, connecting to a phone jack, may be used to transmit phone signals to the caller ID connected to the TV set, such a device incurs extra costs. Additionally, there may be some other devices, such as a video cassette recorder (VCR), a digital versatile disc (DVD) player, a game player, and so on, which need to be connected to the same TV set; and there may not be enough connectors available on the TV set to connect all these devices at the same time. In this situation, a user will be forced to select which devices are connected to the TV at a certain time. This causes inconvenience to the user. Furthermore, current caller ID for a TV set can only allow a caller's phone number/identity to be displayed on the TV screen in certain display modes (e.g., when the TV is showing a broadcasted TV program), but not in other display modes (e.g., when the TV is showing a DVD movie). All of these limitations result in an unfavorable user experience for current TV caller IDs.

### BRIEF DESCRIPTION OF THE DRAWINGS

The features and advantages of the present disclosure will become apparent from the following detailed description of the present disclosure in which:

FIG. 1 shows an example use of a wireless caller ID system in a home environment;

FIG. 2 is a diagram illustrating major components of a wireless caller ID system;

FIG. 3 depicts functional components of a transmitting unit of a wireless caller ID system;

FIG. 4 shows one example embodiment of a transmitting unit used by a wireless caller ID system;

FIG. 5 depicts functional components of a control unit of a wireless caller ID system;

FIG. 6 depicts functional components of a receiving unit of a wireless caller ID system; and

FIG. 7 illustrates a flowchart of an example process for displaying caller ID information wirelessly through a wireless caller ID system.

### DETAILED DESCRIPTION

A wireless caller ID system may display a caller's information (e.g., phone number and identity) on a television screen, a screen of a computer system (e.g., a desktop personal computer (PC) system, a laptop computer system, or a handheld computer system), a separate caller ID device, or any other devices having a display (e.g., a microwave oven, a refrigerator that has a display screen). The wireless caller ID may comprise a transmitting unit, a receiving unit, and a control unit. The transmitting unit is connected to a phone jack to receive phone signals, to extract caller ID information from the phone signals, and to transmit the caller ID information to the receiving unit wirelessly. The receiving unit receives the caller ID information from the transmitting unit and displays information about a caller in a way controlled by the control unit. The receiving unit may further process the caller ID information after receiving it from the transmitting unit so that the information about the caller may be displayed in a desirable manner. The receiving unit may be located inside or be a part of a device such as a TV or a computer system. The receiving unit may also be a separate device which has its own display to show the caller ID information to a user. The control unit also receives the caller ID information from the transmitting unit and, based on the information, determines how to handle the incoming phone call and what information about the caller, if any, the receiving unit should display. The control unit may be located together with, or even integrated into, the receiving unit or the transmitting unit. The control unit may also be located separately from the receiving unit and the transmitting unit, for example, the control unit may be located in a computer system, and the transmitting unit may be located near a phone jack, while the receiving unit may be located in a TV set. The transmitting unit may transmit the caller ID information to the receiving/control unit using any of the well known wireless technologies, e.g., 900 MHz, 2.4 GHz, Bluetooth, 802.11b, 802.11g, etc.

Reference in the specification to “one embodiment” or “an embodiment” of the disclosed techniques means that a particular feature, structure or characteristic described in connection with the embodiment is included in at least one embodiment of the disclosed techniques. Thus, the appearances of the phrase “in one embodiment” appearing in various places throughout the specification are not necessarily all referring to the same embodiment.

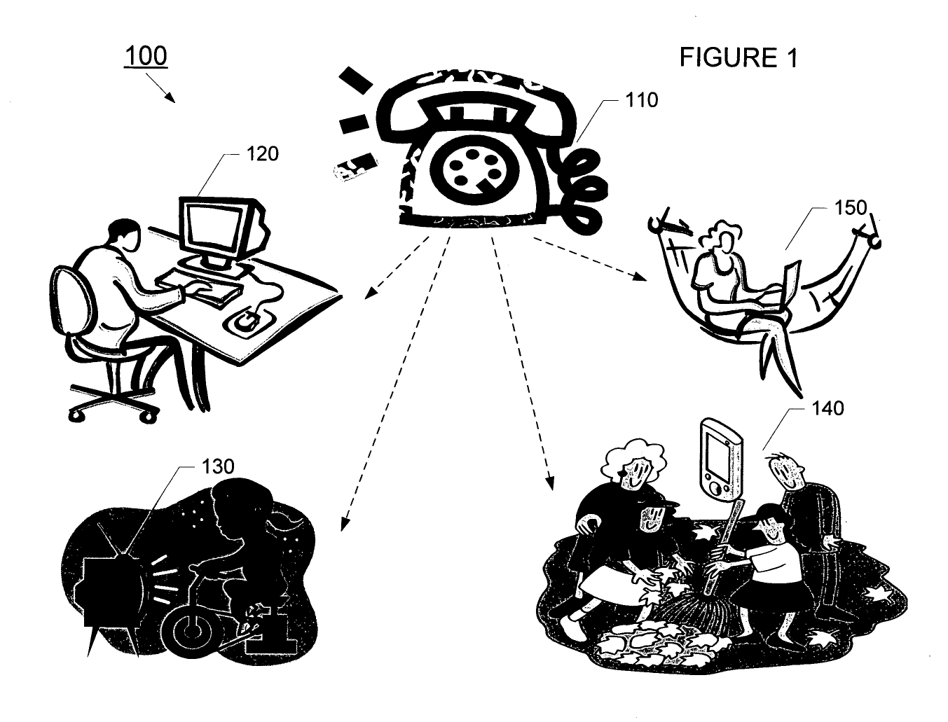

FIG. 1 shows an example use of a wireless caller ID system in a home environment 100. When a phone call comes in, phone 110 rings and at the same time a transmitting unit of the wireless caller ID system receives a phone signal for the incoming call. The transmitting unit extracts caller ID information from the phone signal and transmits the caller ID information wirelessly to a control unit and at least one receiving unit of the wireless caller ID system. The control unit may be located within a computer system (e.g., a desktop computer 120). Based on the caller ID information received from the transmitting unit, the control unit may determine how to handle the incoming call. For example, the control unit may decide not to pick up this call and hence informs receiving units that the incoming call is an unwanted call. The control unit may transmit data to a receiving unit through either a wired connection or wireless connection. There may be more than one receiving unit in a wireless caller ID system. As shown in FIG. 1, each device (e.g., a desktop computer system 120, a TV set 130, a personal directory assistance (PDA) 140, and a laptop computer system 150) may have a receiving unit. Each receiving unit receives the caller ID information from the transmitting unit and displays information about a caller according to instructions from the control unit.

Although not shown in the figure, a receiving unit may be built as an independent device primarily for displaying information about a caller. Because of a wireless connection between the transmitting unit and the receiving/control unit, the receiving/control unit does not need to be connected to a phone jack via telephone lines and may even be moved around. For example, the PDA 140 with a receiving unit may be used to display information about a caller while people are doing yard work; the laptop 150 with a receiving unit may be used to display information about a caller while a person is outside a home.

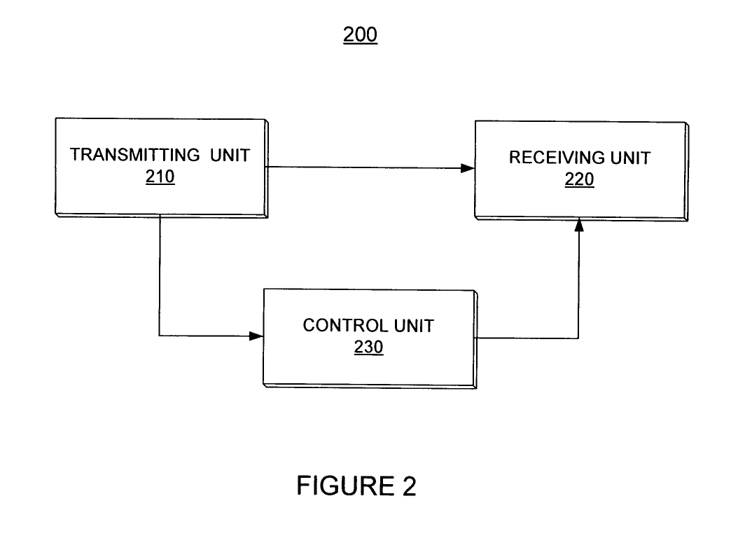

FIG. 2 is a diagram illustrating major components of a wireless caller ID system 200, according to an embodiment of the present disclosure. The wireless caller ID system 200 may comprise a transmitting unit 210, at least one receiving unit 220, and a control unit 230. The transmitting unit 210 is connected to a phone jack and receives a phone signal for an incoming call. The transmitting unit may process the phone signal and decode/extract caller ID information from the phone signal. Subsequently, the transmitting unit may transmit the caller ID information wirelessly to the receiving unit 220 and the control unit 230. The caller ID information includes at least a phone number of a caller and probably other information about a caller (e.g., name of the caller).

When the control unit 230 receives the caller ID information transmitted by the transmitting unit 210, it may determine how to handle this call and accordingly issue corresponding control data to the receiving unit 220 so that appropriate information may be displayed for a receiving party. For example, the phone number of the caller may be among a list of phone numbers from which the receiving party does not want to receive any calls. In this case, the control unit may automatically reject the call and direct the receiving unit to display corresponding information (e.g., “unwanted call”). In one embodiment, the control unit may be integrated with the transmitting unit, and the control data as well as any other data may be transmitted to the receiving unit along with the caller ID information. In another embodiment, the control unit may be integrated with the receiving unit. For example, the control unit and the receiving unit may be combined and located in a computer system (e.g., a desktop computer 120 as shown in FIG. 1). Yet in another embodiment, the control unit may be separate from the transmitting unit and the receiving unit. The control unit may be implemented in hardware or software or a combination of both. In one embodiment, most functions of a control unit may be implemented as a software application executed by a computer system. The control unit may utilize any existing components of the computer system to receive caller ID information and to transmit data to a receiving unit. In another embodiment, the control unit may be implemented using specially designed circuitry.

The receiving unit 220 may receive the caller ID information from the transmitting unit 210. The receiving unit may further process the received caller ID information according to instructions from the control unit. For example, the control unit may direct the receiving unit to display information (e.g., a picture of a caller) in addition to the information included in the caller ID information received from the transmitting unit 210. The receiving unit may accordingly arrange all the information about the caller properly and cause it to be displayed on a screen (e.g., a computer screen or a TV screen). The receiving unit 220 may be implemented by hardware, software, or a combination of both. When implemented at least partly in hardware, a receiving unit may, in one embodiment, be implemented as a relatively separate unit that is coupled to an associated device (e.g., a TV set and a computer); or in another embodiment, be implemented as an integral part of the device. Yet in another embodiment, the receiving unit may be an independent device designed primarily for displaying caller ID information.

The transmitting unit 210 may use any available wireless technologies (e.g., 900 MHz or 2.4 GHz radio frequency transmission, Bluetooth, 802.11 technologies) to transmit the caller ID information to the receiving unit 220 and the control unit 230. The connection between the control unit and the receiving unit may be wired or wireless. For example, if the control unit is located inside a desktop computer, the control unit may be connected to a receiving unit inside a TV set, through a home network cable or wirelessly; and the connection between the control unit and receiving units inside a PDA and a laptop computer may be wireless. In one embodiment, only the control unit may receive the caller ID information from the transmitting unit; it may determine what information should be displayed by a receiving unit based on the received caller ID information and then send such information to a receiving unit to display. In any embodiment, the control unit may send different information/control data to different receiving units based on processing capabilities of receiving units.

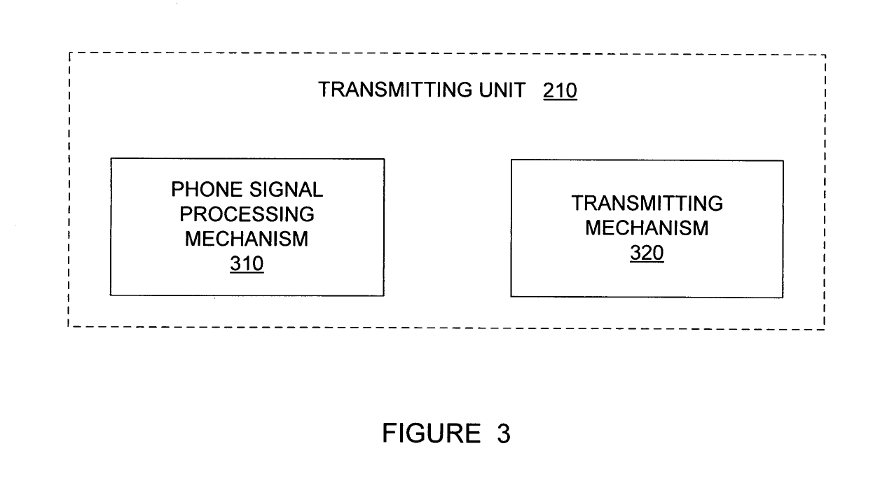

FIG. 3 depicts functional components of a transmitting unit 210 of a wireless caller ID system as shown in FIG. 2, according to an embodiment of the present disclosure. The transmitting unit is connected to a phone jack through a telephone line. In one embodiment, the transmitting unit may be capable of directly connecting to a phone jack without a phone line. The transmitting unit may comprise a phone signal processing mechanism 310 and a transmitting mechanism 320. The phone signal processing mechanism 310 receives a phone signal for an incoming call from a phone jack. The phone signal also processes the phone signal to extract caller ID information. The transmitting mechanism 320 receives the extracted caller ID information from the phone signal processing mechanism 310 and transmits it wirelessly to a receiving/control unit. The transmitting mechanism may use any available wireless technologies such as 900 MHz/2.4 GHz radio transmission technologies, Bluetooth, and 802.11 technologies. The transmitting mechanism may choose one wireless technology (e.g., 802.11b) in order to be compatible with wireless capabilities of other home devices (e.g., a TV set, a computer system) that may have a receiving unit for displaying information for a caller.

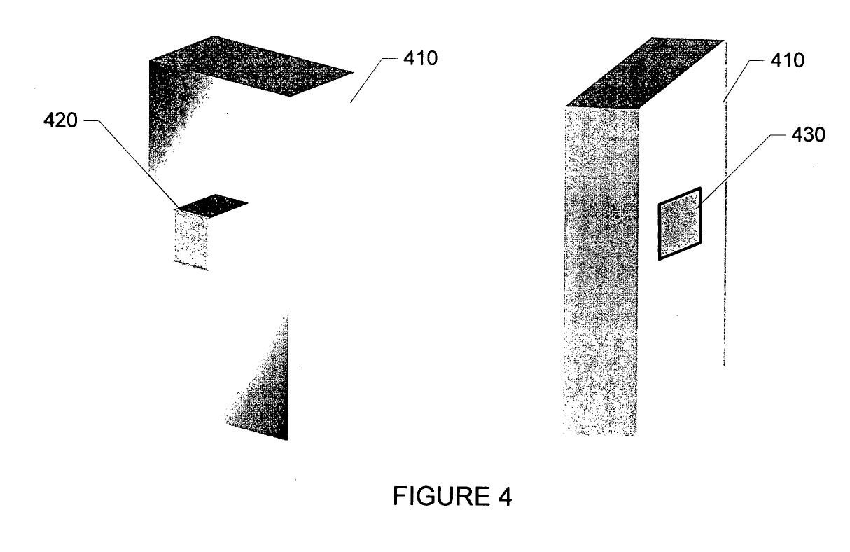

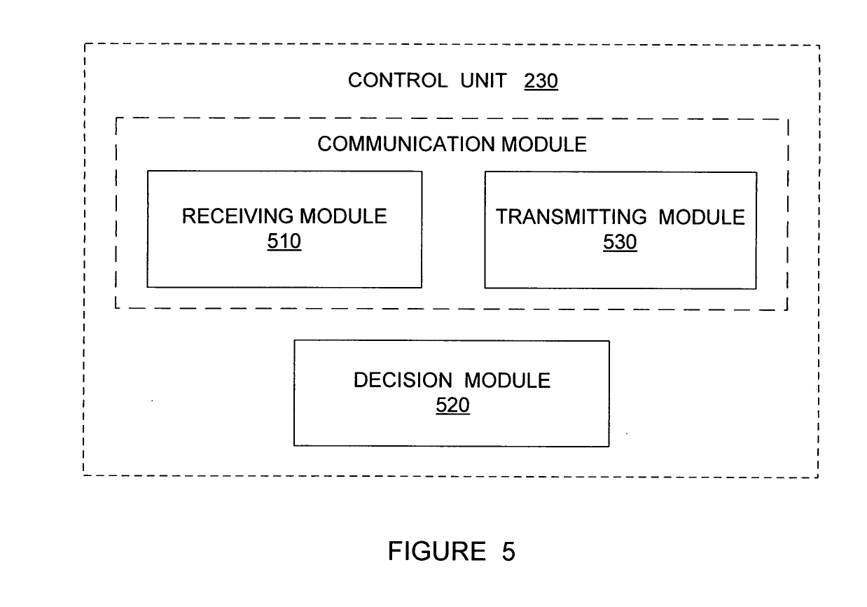

FIG. 4 shows one example embodiment of a transmitting unit used by a wireless caller ID system. In this example embodiment, the transmitting unit, including a phone signal processing mechanism and a transmitting mechanism, may be enclosed in a case 410. On one side of the case 410, there is a projected connector 420 for plugging into a phone jack in a wall. On another side of the case 410, there is a built-in pass-through phone jack 430 for connecting to other phone devices (e.g., a phone set or another caller ID device). Although not shown in FIG. 5, there may also be an antenna coupled to the case 410 to facilitate transmission of caller ID information by the transmitting mechanism inside the case. FIG. 4 only shows one embodiment, but there may be many other embodiments available for the transmitting unit, which can be readily made by a person of ordinary skill in the art enlightened by this disclosure.

FIG. 5 depicts functional components of a control unit 230 of a wireless caller ID system as shown in FIG. 2, according to an embodiment of the present disclosure. The control unit 230 may comprise a receiving module 510, a decision module 520, and a transmitting module 530. In one embodiment, the receiving module 510 receives a signal which includes caller ID information, transmitted wirelessly by a transmitting unit of the wireless caller ID system. The receiving module may demodulate/decode the signal from the transmitting unit to obtain the caller ID information. In another embodiment, the receiving module 510 may receive a phone signal which includes caller ID information, directly from a phone line and decode/extract the caller ID information from the phone signal.

The decision module 520 may decide how to handle an incoming call based on the caller ID information obtained by the receiving module 510. The control unit may maintain a call information database which keeps track of history of calls from a caller or a phone number. Based on prior call history for a caller or a phone number, such a caller/phone number may be marked as “unwanted,” “automatic reply with message x” (x represents a specific message), “direct to answering machine,” etc. The call information database may be updated by a user either manually or by automatically tracking a user's responses to each phone call. The decision module may check the call information database for an incoming call. If is marked as an unwanted call, the decision module may let receiving units of the wireless caller ID system show that this is an unwanted call or simply reject the incoming call and not let the receiving units display anything for a receiving party. The decision module may also automatically reply to an incoming call using a pre-recorded message according to relevant data in the call information database; and let the receiving units show that a call with the caller ID information has been automatically replied to with a certain pre-recorded message, or let the receiving units show nothing. Additionally, the decision module may direct a caller to leave a voice message. Moreover, the decision module may decide to provide a receiving party more information about the incoming call than that provided by the caller ID information. For example the decision module may direct the receiving units to display a picture of the caller and/or a short description of the caller or the calling number. Although a few functions of the decision module are described here, a person of ordinary skill in the art may readily derive other functions for the decision module according to this disclosure.

The transmitting module of the control unit may transmit control instructions as well as other data (together will be referred to as “data” in general) from the control unit to receiving units of a wireless caller ID system. The data may be transmitted through wired and/or wireless connections. For example, the data may be transmitted to a receiving unit through a home network cable or but to another receiving unit through a wireless home network. The transmitting module may be combined with the receiving module to form a communication module.

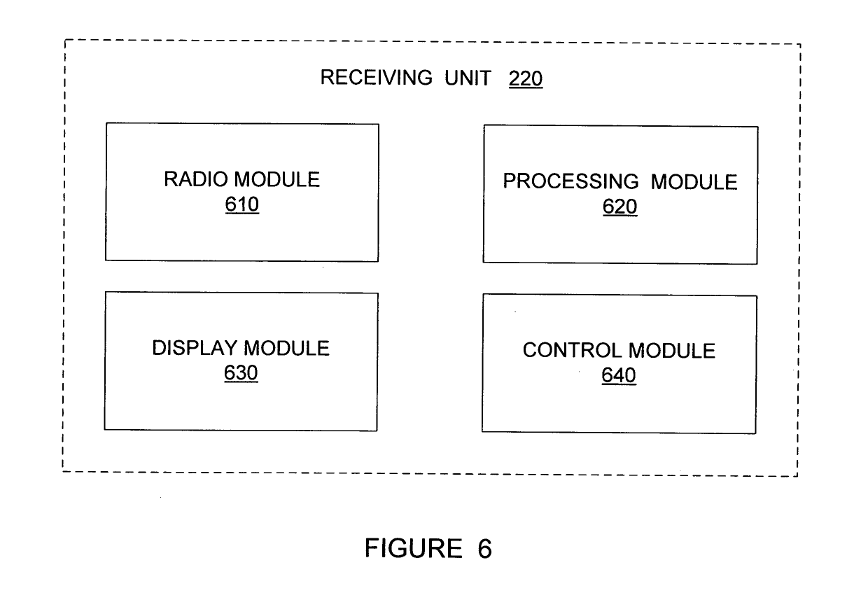

FIG. 6 depicts functional components of a receiving unit 220 of a wireless caller ID system as shown in FIG. 2, according to an embodiment of the present disclosure. The receiving unit 220 may comprise a radio module 610, a processing module 620, a display module 630, and a control module 640. The radio module 610 receives a signal which includes caller ID information, transmitted wirelessly by a transmitting unit of the wireless caller ID system. The radio module needs to use a wireless technology that is compatible with the one used by a transmitting unit of the wireless caller ID system. The receiving module may also demodulate/decode the signal from the transmitting unit to obtain the caller ID information, depending on what format is used to transmit the caller ID information by the transmitting unit. Additionally, the radio module may receive instructions and other additional data (e.g., data of a caller's picture) from the control unit wirelessly. The radio module may have an antenna to help receive data wirelessly.

The processing module 620 may further process the caller ID information received from the radio module 610, according to instructions from a control unit of the wireless caller ID system. The processing module may select a portion of, add additional information to, or transform the caller ID information according to instructions from the control unit; and send the processed caller ID information to the display module to display to a user. For example, if the control unit instructs the processing module that an incoming call is unwanted, the processing module may send a corresponding signal to the display module to show a user that the incoming call is unwanted. If the control unit instructs the processing module that a call is to be automatically replied to with a pre-recorded message, the processing module may form a signal so that the display module will show the user that the incoming call has been automatically replied to with the pre-recorded message. If the control unit instructs the processing module that additional information (e.g., a picture of the caller) is needed, the processing module may generate a signal based on the caller ID information received from the radio module and additional information received from the control unit; and send the generated signal to the display module for displaying to the user.

The display module 630 helps display information about a call received from the processing module 620 on a screen. In some embodiments, the display module 630 may comprise a graphics controller which causes the information about a call to display on a screen of a device (e.g., a TV set or a computer system) inside which a receiving unit is located. There may be many different graphics modes or resolutions for the device. The display module ensures that the information about a call be displayed on the screen regardless of what graphics mode or resolution the device is using. The display module may utilize an existing graphics controller of the device to display the information about a call or may have its own graphics controller which coordinates with the device's graphics controller to cause the information about a call to be displayed.

The control module 640 of the receiving unit 220 may determine how the information about a call provided by the processing module 620 is displayed on a screen. For example, the control module may decide at what position of a screen and in what color or style the information should be displayed. The control module may also consider the current graphic mode or resolution a device is using when deciding a manner for displaying the information. For example, if in a current graphics mode, there can be captions displayed at the bottom of a screen, the control module may decide to display the call information in a position other than the bottom portion of a screen.

If, for example, the receiving unit is located in a TV set, the receiving unit may be implemented as a plug-in card, or be implemented by modifying relevant parts of the TV. If a plug-in card is used, a part or all of the radio module, processing module, display module, and/or control module may be located in the card. A portion of the functions performed by these modules may be achieved by existing components of the TV set with or without modifications. For example, the plug-in card may have a display module which comprises a graphics controller. The plug-in card might not have its own graphics controller but uses the graphics controller of the TV. If the receiving unit is implemented by modifying relevant parts of the TV, functions of the radio module may be achieved by modifying a corresponding part of the TV. For example, some TV sets today can communicate with a computer system wirelessly. The part that receives signals from a computer wirelessly may be modified to receive caller ID information from a transmitting unit of a wireless caller ID system. Functions of the display module may be achieved by using an on-screen-display (OSD) module in a TV set or by adding an additional overlay plane to the current TV displaying system.

Similarly, a computer system may be used to perform functions of a receiving unit of a wireless caller ID system. If the computer is capable of communicating with other devices wirelessly, on one hand, parts responsible for such wireless communications may be adapted to also receive caller ID information transmitted wirelessly by a transmitting unit. On the other hand, a radio module may be added to a computer system to receive caller ID information from the transmitting unit, if the computer system is not already capable of performing such a task. Once the caller ID information is properly received, functions of the processing module, the display module, and the control module of a receiving unit may be implemented by software applications.

In one embodiment of a wireless caller ID system, the transmitting unit may be omitted and the control unit, particularly the receiving module of the control unit, receives an incoming phone call through a phone line. The receiving module also extracts caller ID information from the incoming phone signal. The decision module of the control unit may determine how to handle the call based on the caller ID information. The decision module further forms an output signal which includes information to be displayed by a receiving unit. The transmitting module of the control unit then sends the output signal to all the receiving units in the wireless caller ID system, through either wired or wireless connections. The transmitting module has the capability to transmit data wirelessly to receiving units so that different devices that have a receiving unit can receive information about the incoming phone call anywhere around a house. For a receiving unit, the radio module is capable of receiving data sent from the control unit through either wired or wireless connections. Because a receiving unit receives information about the incoming phone call directly from the control unit, there may be no need for a receiving unit to have a processing module. The display module may cause the information to be displayed on a screen of a device in which the receiving unit is located. The control module may control how the information is displayed on the screen.

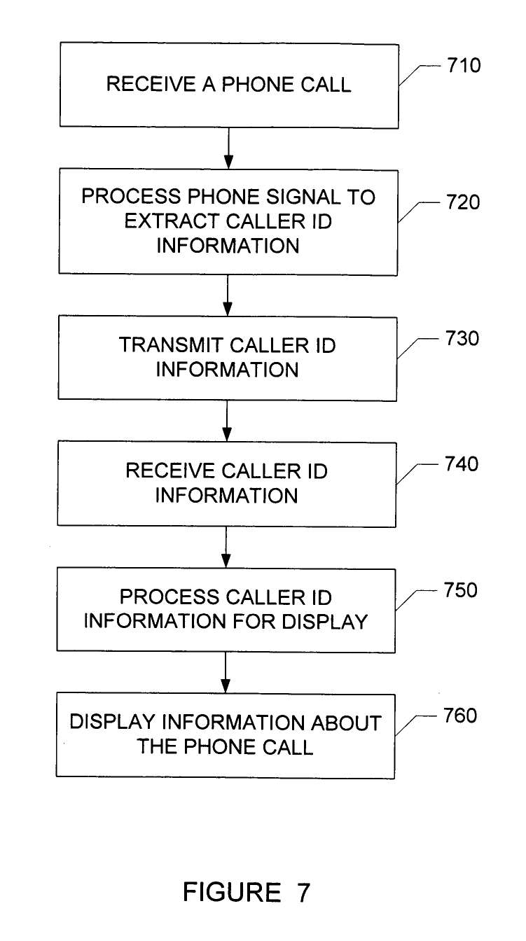

FIG. 7 illustrates a flowchart of an example process for displaying caller ID information wirelessly through a wireless caller ID system. At block 710, an incoming call may be received by a transmitting unit. At block 720, the signal of the incoming call may be processed to extract caller ID information. At block 730, the extracted caller ID information may be transmitted wirelessly to a receiving unit and/or a control unit of the wireless caller ID system. At block 740, the caller ID information for the incoming call may be received by the receiving unit and the control unit. Since the control unit may be located in a computer that has a phone line connection, the control unit may receive the caller ID information from the computer's existing phone line connection. The control unit may determine how to handle the incoming call based on the caller ID information and accordingly send instructions/additional data to all receiving units in the wireless caller ID system. At block 750, the caller ID information may be further processed by a receiving unit according to instructions from the control unit. The receiving unit may use additional data from the control unit when processing the caller ID information. At block 760, information about the incoming call may be displayed by the receiving unit on a screen of a device where the receiving unit is located (e.g., a TV, a PC, etc.). The information about the incoming call may include the phone number, the caller's name, the caller's picture, the prior history of the caller or calls from the phone number, notification that the call is an unwanted call, notification that the call has been automatically replied with a specific message, etc.

Although an example embodiment of the disclosed techniques is described with reference to diagrams in FIGS. 1-7, persons of ordinary skill in the art will readily appreciate that many other structures and methods of implementing the present invention may alternatively be used. For example, the order of execution of the functional blocks or process procedures may be changed, and/or some of the structures, functional blocks or process procedures described may be changed, eliminated, or combined.

In the preceding description, various aspects of the disclosed techniques have been described. For purposes of explanation, specific numbers, systems and configurations were set forth in order to provide a thorough understanding of the present disclosure. However, it is apparent to one skilled in the art having the benefit of this disclosure that the present disclosure may be practiced without the specific details. In other instances, well-known features, components, or modules were omitted, simplified, combined, or split in order not to obscure the present disclosure.

Embodiments of the present techniques described herein may be implemented in circuitry, which includes hardwired circuitry, digital circuitry, analog circuitry, programmable circuitry, and so forth. They may also be implemented in computer programs. Such computer programs may be coded in a high level procedural or object oriented programming language. However, the program(s) can be implemented in assembly or machine language if desired. The language may be compiled or interpreted. Additionally, these techniques may be used in a wide variety of networking environments. Such computer programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the disclosure may also be considered to be implemented as a machine-readable storage medium, configured for use with a processing system, where the storage medium so configured causes the processing system to operate in a specific and predefined manner to perform the functions described herein.

While the disclosed techniques have been described with reference to illustrative embodiments, this description is not intended to be construed in a limiting sense. Various modifications of the illustrative embodiments, as well as other embodiments of the disclosure, which are apparent to persons skilled in the art to which the disclosure pertains are deemed to lie within the spirit and scope of the disclosure.

What is claimed is:

1. A wireless caller ID system, comprising:
a transmitting unit to receive an incoming phone call and to transmit caller ID information included in a signal of the incoming phone call;
a control unit to determine handling instructions for the incoming phone call; and
at least one receiving unit to display information about the incoming phone call according to the handling instructions from the control unit;
wherein the transmitting unit transmits the caller ID information to at least one of the control unit and one of the at least one receiving unit wirelessly.

2. The system of claim 1, wherein the transmitting unit comprises:
a phone signal processing mechanism to extract caller ID information from the incoming phone signal; and
a transmitting mechanism to transmit the caller ID information to at least one of the control unit and one of the at least one receiving unit wirelessly.

3. The system of claim 2, wherein the phone signal processing mechanism and the transmitting mechanism are enclosed in a case, the case having a phone jack connector on one side and a built-in phone jack on another side.

4. The system of claim 1, wherein the control unit comprises:
a communication module to receive an input signal, the input signal including the caller ID information; and
a decision module to determine how to handle the incoming phone call based at least in part on the caller ID information, and to form the handling instructions for the at least one receiving unit to process the caller ID information of the incoming phone call;
wherein the communication module transmits the instructions to one of the at least one receiving unit.

5. The system of claim 4, wherein the communication module comprises a receiving module to receive the input signal and a transmitting module to transmit data to a receiving unit, the data including the handling instructions.

6. The system of claim 1, wherein the at least one receiving unit comprises:
a radio module to receive data transmitted wirelessly from at least one of the transmitting unit and the control unit, the data including at least one of the caller ID information and the handling instructions;
a processing module to produce a signal for the incoming phone call based at least in part on the handling instructions, the signal including information to be displayed on a screen; and
a display module to cause the signal to be displayed on a screen of a device, the device including one of the at least one receiving unit.

7. The system of claim 6, wherein the at least one receiving unit further comprises a control module to control how information about the incoming phone call is displayed on the screen.

8. The system of claim 6, wherein the radio module comprises an antenna to receive the signal.

9. The system of claim 6, wherein the at least one receiving unit is integral with a television set (TV) and the display module of the at least one receiving unit causes information about the incoming phone call displayable on a screen of the TV in any display mode of the TV.

10. A wireless caller ID system, comprising:
a control unit to receive an incoming phone call, to determine handling instructions for the incoming phone call, and to send data to a receiving unit, the data including the handling instructions and information about the incoming phone call; and
a plurality of receiving units to receive the data from the control unit and to cause the information about the phone call to be displayed on a screen according to the handling instructions;
wherein the data was sent to at least one receiving unit wirelessly.

11. The system of claim 10, wherein the control unit comprises:
a communication module to receive an input signal of the incoming phone call; and
a decision module to determine the handling instructions for the incoming phone call based at least in part on caller ID information extracted from the input signal, and to produce an output signal, the output signal including information about the incoming phone call that is to be displayed by the plurality of receiving units;
wherein the communication module transmitting the output signal to the plurality of receiving units.

12. The system of claim 11, wherein the communication module comprises a receiving module to receive the input signal and a transmitting module to transmit the output signal to the plurality of receiving units, the transmitting module being capable of transmitting the output signal wirelessly.

13. The system of claim 10, wherein each receiving unit comprises a radio module to receive at least the output signal from the control unit, the radio module being capable of receiving the data wirelessly;
a display module to cause the information about the incoming phone call to be displayed on a screen of a device in which the receiving unit resides; and
a control module to control how the information about the incoming phone call is displayed on the screen.

14. The system of claim 13, wherein the radio module comprises an antenna to receive the output signal.

15. The system of claim 13, wherein the receiving unit is integral with a television set (TV) and the display module of the receiving unit causes the information about the incoming phone call displayable on a screen of the TV in any display mode of the TV.

16. A method for displaying information about a call wirelessly, comprising:
receiving an input signal of an incoming phone call;
processing the input signal to extract caller ID information;
transmitting the caller ID information wirelessly to at least one device;
determining what information about the incoming phone call is to be displayed on the at least one device, based at least in part on the caller ID information; and
displaying the determined information about the incoming phone call on the at least one device.

17. The method of claim 16, further comprising:
receiving the caller ID information by the at least one device; and
processing the received caller ID information to produce an output signal, the output signal including the determined information about the incoming phone call.

18. The method of claim 16, wherein the at least one device comprises a television set.

19. The method of claim 16, wherein displaying the determined information about the incoming phone call on the at least one device comprises displaying the determined information on a screen of the at least one device in any display mode of the at least one device.

20. A method for displaying information about a call wirelessly, comprising:
receiving an input signal of an incoming phone call;
processing the input signal to extract caller ID information;
determining what information about the incoming phone call is to be displayed on at least one device, based at least in part on the caller ID information;
producing an output signal, the output signal including the determined information about the incoming phone call to be displayed on the at least one device;
transmitting the output signal to the at least one device; and
displaying the determined information about the incoming phone call on the at least one device.

21. The method of claim 20, wherein transmitting the output signal comprises transmitting the output signal to the at least one device wirelessly.

22. The method of claim 20, further comprising receiving the output signal by the at least one remote device, the receiving the output signal including receiving the output signal wirelessly by the at least one remote device.

23. The method of claim 20, wherein the at least one device comprises a television set.

24. The method of claim 20, wherein displaying the determined information about the incoming phone call on the at least one device comprises displaying the determined information on a screen of the at least one device in any display mode of the at least one device.
